(19) United States
(12) Patent Application Publication
(10) Pub. No.: US 2014/0376037 A1
(43) Pub. Date: Dec. 25, 2014

(54) IMAGE TRANSMISSION SYSTEM, IMAGE READING COMMUNICATION APPARATUS, MOBILE TERMINAL, AND METHOD FOR TRANSMITTING IMAGE

(71) Applicant: Sharp Kabushiki Kaisha, Osaka (JP)

(72) Inventor: Kenji ONOGI, Osaka-shi (JP)

(73) Assignee: Sharp Kabushiki Kaisha, Osaka (JP)

(21) Appl. No.: 14/250,653

(22) Filed: Apr. 11, 2014

(30) Foreign Application Priority Data
Jun. 21, 2013 (JP) 2013-130978

(51) Int. Cl. G06F 3/12; H04N 1/00

(52) U.S. Cl. CPC G06F 3/1292; G06F 3/1238; H04N 1/00106
USPC 358/1.15

(57) ABSTRACT

The image reading device (i) reads an image, (ii) causes a server, which is provided on a network, to store the image, and (iii) receives, from the server, access information that is used to access the server so as to obtain the stored image. After the image is read, the image reading device transmits the access information, which has been received from the server, to a mobile terminal with which short range wireless communication has been established. Upon receipt of the access information, the mobile terminal prepares an email which contains the received access information and indicates that the image is stored in the server and then transmits the email to an information terminal which is indicated by address information set as a destination by a user.

This Nonprovisional application claims priority under 35 U.S.C. §119 on Patent Application No. 2013-130978 filed in Japan on Jun. 21, 2013, the entire contents of which is hereby incorporated by reference.

### TECHNICAL FIELD

The present invention relates to an image transmission system for transmitting, to an arbitrary information terminal, an image which has been read by an image reading communication apparatus that has an image reading function and a communication function.

### BACKGROUND ART

Image reading communication apparatuses (hereinafter, simply referred to as “reading communication apparatus”) such as a multifunction peripheral and an image reading device having a communication function have a mode in which an image, which has been read by a scanner section, is transmitted to an arbitrary information terminal from a communication section which is connected with a network. In this case, every time a user transmits an image, the user operates an operation panel or the like, which is provided to the reading communication apparatus, so as to (i) input destination information (e.g., email address) of a destination to which the image is to be transmitted or (ii) select such destination information from pieces of destination information registered on a storage section of the reading communication apparatus.

The reading communication apparatus further has a mode in which an image read by the scanner section is stored in a server. By utilizing such a mode, read images are transmitted and received via the server. In this case, the user notifies, by email, telephone, or the like, a receiver of access information which is necessary for the receiver to access the server so as to obtain an image stored in the server. Examples of the access information encompass address information of the server and a file number of a stored image.

Patent Literature 1 discloses an image forming apparatus in which a way of supplying an image file is determined in advance depending on receivers, and an image file obtained by scanning is supplied, depending on a size of the image file, (1) by transmitting email to which the image file is attached or (2) by transmitting email that contains a link URL indicative of a location at which the image file is stored. In this case, the user who is a sender registers in advance, on a storage section of the image forming apparatus, (i) pieces of destination information of receivers to each of which an image is to be transmitted and (ii) ways of supplying an image depending on the receivers.

### CITATION LIST

### Patent Literature

[Patent Literature 1]

Japanese Patent Application Publication, Tokukai No. 2011-135420 A (Publication date: Jul. 7, 2011)

### SUMMARY OF INVENTION

### Technical Problem

However, the conventional techniques have a problem that the user is forced to carry out the troublesome procedures in order to transmit an image, which has been read by the reading communication apparatus, to a receiver.

In order to transmit an image, which has been read by the reading communication apparatus, directly to a receiver, it is necessary (i) to input destination information into the reading communication apparatus every time the image is transmitted or (ii) to register destination information in advance on the reading communication apparatus. The input of destination information into the reading communication apparatus is generally carried out by operating a keyboard and the like included in an address input screen, which is displayed on a display section of an operation panel provided to the reading communication apparatus. However, the input of destination information via the address input screen displayed on the operation panel of the reading communication apparatus is troublesome work and requires time, as compared with an input of destination information with the use of a mobile phone or a smart phone that has been variously elaborated so that the input can be easily carried out. Therefore, if a user needs to input destination information via the operation panel of the reading communication apparatus for each transmission, this forces the user to carry out exceedingly troublesome procedures.

In a case where pieces of destination information are registered in advance on the storage section of the reading communication apparatus, a transmission of image can be carried out with a simple operation because destination information can be inputted merely by selecting the destination information from pieces of registered destination information. However, this case also requires an input of destination information via the address input screen which is displayed on the operation panel of the reading communication apparatus. Alternatively, in a case where an image is read and transmitted with the use of a shared multifunction peripheral (which is one of reading communication apparatuses) placed in a convenience store or the like, destination information cannot be inputted in advance and therefore destination information needs to be inputted for each transmission.

Meanwhile, according to the technique in which a read image is transmitted and received via the server, it is unnecessary to input destination information into the reading communication apparatus. However, this technique ultimately requires a tiresome procedure, that is, it is still necessary to additionally notify a receiver of access information by email, telephone, or the like.

The present invention is accomplished in view of the problems, and its object is to provide an image transmission system and the like which make it possible to transmit an image, which has been read by an image reading communication apparatus, to a receiver with a simpler operation.

### Solution to Problem

In order to attain the object, an image transmission system in accordance with an aspect of the present invention includes: an image reading communication apparatus that includes a scanner section for reading an image, a first network communication device for carrying out communication via a network, and a first short-range communication device for carrying out short range wireless communication; and a mobile terminal that includes a second network communication device for carrying out communication via the network, a second short-range communication device for carrying out the short range wireless communication, email means for preparing an email and controlling the second network communication device to transmit the email, and address information managing means for managing address information of an information terminal to which the email is transmitted, the image reading communication apparatus further including: storing means for externally storing an image, the storing means (i) controlling the scanner section to read an image, (ii) controlling the first network communication device to transmit the image, which has been read, to a server so that the image is stored in the server, and (iii) receiving, from the server, access information which is used to access the server so as to obtain the image stored in the server, and access information transmitting means for controlling, after the image is read by the scanner section, the first short-range communication device to transmit the access information to the mobile terminal with which a pairing has been established, the mobile terminal further including: access information receiving means for controlling the second short-range communication device to receive the access information from the image reading communication apparatus with which the pairing has been established, informative mail preparing means for preparing, with use of the email means, an informative mail which (i) contains the access information which has been received from the image reading communication apparatus and (ii) indicates that the image is stored in the server, address information setting means for setting, with use of the address information managing means, address information that indicates a destination of the informative mail, and informative mail transmitting means for controlling the second network communication device to transmit the informative mail to an information terminal which is indicated by the address information.

### Advantageous Effects of Invention

According to an aspect of the present invention, it is possible to bring about an effect of providing the image transmission system and the like which make it possible to transmit an image, which has been read by the image reading communication apparatus, to a receiver with a simpler operation.

### BRIEF DESCRIPTION OF DRAWINGS

FIG. 1 is an explanatory view illustrating a configuration of an image transmission system in accordance with an embodiment of the present invention.

FIG. 2 is an explanatory view schematically illustrating a case in which an image is transmitted with the use of the image transmission system illustrated in FIG. 1.

FIG. 3 is a block diagram illustrating an example of a hardware configuration of an image reading device in the image transmission system illustrated in FIG. 1.

FIG. 4 is a block diagram illustrating an example of a hardware configuration of a mobile terminal in the image transmission system illustrated in FIG. 1.

FIG. 5 is a block diagram illustrating an example of a hardware configuration of an external server for storing an image, which external server is connected via a network with the image reading device of the image transmission system illustrated in FIG. 1.

FIG. 6 is a flowchart illustrating an operation of the image reading device in the image transmission system illustrated in FIG. 1.

FIG. 7 is a flowchart illustrating an operation of the mobile terminal in the image transmission system illustrated in FIG. 1.

FIG. 8A is a flowchart illustrating an operation of a server in the image transmission system illustrated in FIG. 1.

FIG. 8B is a flowchart illustrating a subroutine in the flowchart of FIG. 8A and indicating an operation carried out in the process of reservation for storing image data.

FIG. 8C is a flowchart illustrating a subroutine in the flowchart of FIG. 8A and indicating an operation carried out in the process of receiving and storing image data.

FIG. 8D is a flowchart illustrating a subroutine in the flowchart of FIG. 8A and indicating an operation carried out in the process of transmitting image data.

### DESCRIPTION OF EMBODIMENTS

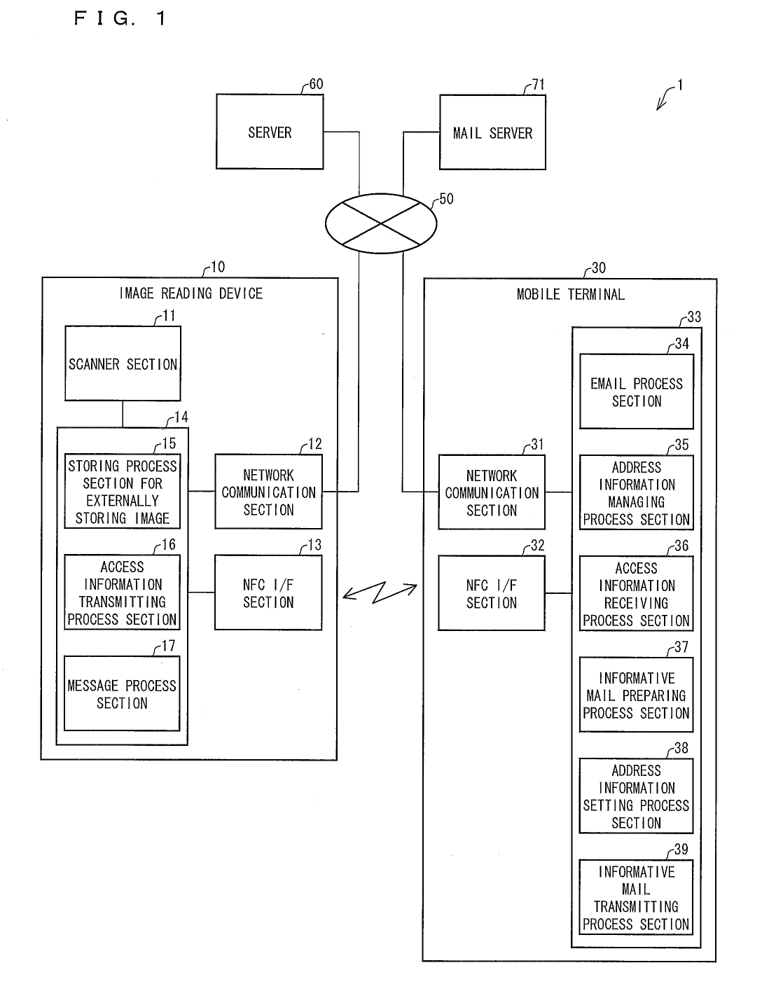

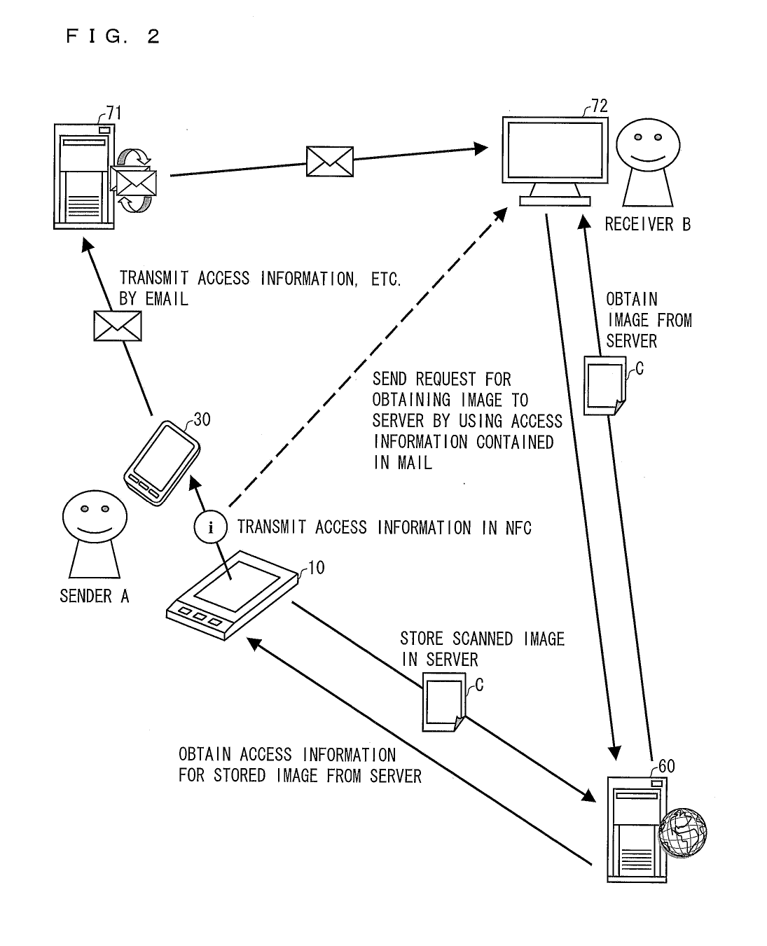

The following description will discuss details of an embodiment of the present invention. FIG. 1 is an explanatory view illustrating a configuration of an image transmission system in accordance with the present embodiment. FIG. 2 is an explanatory view schematically illustrating a case in which an image is transmitted with the use of the image transmission system of the present embodiment.

According to an image transmission system 1 of the present embodiment, a sender A selects an external storage mode, in which an image is externally stored, of an image reading device (image reading communication apparatus) 10 and then causes an image C to be read by the image reading device 10 (see FIG. 2). The image reading device 10 (i) transmits the image C (to be exact, this should be expressed as “image data of the image C” but, for convenience, this is sometimes simply referred to as “image C”), which has been read, to a server 60 so that image data of the image C is stored in the server 60 and (ii) obtains, from the server 60, access information which is necessary to access the server 60 so as to obtain the image C which is stored in the server 60.

When the sender A brings, after the image C has been read, a mobile terminal 30 near to a specific location at which short range wireless communication such as Near Field Communication (NFC) can be carried out with the image reading device 10, a pairing of the image reading device 10 and the mobile terminal 30 is started. Once the pairing is established (i.e., communication is established), the image reading device 10 transmits, to the mobile terminal 30, the access information which has been obtained from the server.

Subsequently, the sender A operates the mobile terminal 30 so as to set, to a destination of email, address information of an information terminal 72 which is owned by a receiver B to whom the image C is to be transmitted. When an instruction on transmitting an email is given to the mobile terminal 30 from the sender A, the mobile terminal 30 (i) prepares an informative mail which is an email containing the access information received from the image reading device 10 and indicating that the image C is stored in the server 60 and then (ii) transmits the informative mail to the receiver B.

The informative mail is transmitted to the information terminal 72 of the receiver B via a mail server 71, and accordingly the receiver B can access the server 60 so as to obtain the image C via the information terminal 72 with reference to the access information which is contained in the informative mail.

The image transmission system 1, which allows such an image transmission, includes the image reading device 10 and the mobile terminal 30 which can communicate with each other via a peer to peer (P2P) connection in short range wireless communication (see FIG. 1). The image reading device 10 is connected with the server 60, which is an external server for storing an image, via a network 50 that includes the Internet, a LAN, and the like. The mobile terminal 30 is connected with the mail server 71 via the network 50.

(Configuration of Image Reading Device 10)

The image reading device 10 includes at least a scanner section 11, a network communication section 12, an NFC interface section (hereinafter, referred to as NFC I/F section) 13, and a control section 14 (see FIG. 1).

The scanner section 11 is configured by, for example, a CCD sensor and reads an image so as to generate image data of the image. The network communication section (network communication device, first network communication device) 12 is a network communication device for carrying out communication via a network. Specifically, the network communication section 12 communicates with the server 60 via the network 50.

The NFC I/F section (short-range communication device, first short-range communication device) 13 is a short-range communication device that carries out short range wireless communication. Specifically, the NFC I/F section 13 carries out P2P communication with the mobile terminal 30 that is compatible with Near Field Communication (NFC). In this case, the short range wireless communication is exemplified by NFC. Note, however, that infrared communication or the like that has high directivity can alternatively be employed.

The control section 14 includes a CPU (Central Processing Unit) and controls each of the sections of the image reading device 10. For example, the control section 14 carries out a necessary image processing with respect to image data which has been obtained by the scanner section 11. Moreover, in a case where the mobile terminal 30, which has a NFC function, approaches a specific location at which communication with the NFC I/F section 13 can be carried out, the control section 14 controls the NFC I/F section 13 to start a pairing with the mobile terminal 30.

Further, the present embodiment is characterized in that, the control section 14 (i.e., the CPU) serves, by executing an image transmitting program, as a storing process section 15 for externally storing an image, an access information transmitting process section 16, and a message process section 17.

The storing process section 15 (for externally storing an image) controls the scanner section 11 to read an image, and then controls the network communication section 12 to transmit the read image (i.e., image data) to the server 60 so that the image data is stored in the server 60. Further, the storing process section 15 receives, from the server 60, access information which is necessary to access the server 60 so as to obtain the image stored in the server 60. The access information contains information such as address information of the server 60 and a file number of the stored image.

Note that, after the image has been read, the storing process section 15 carries out, with respect to the server 60, a reservation for storing image data, instead of immediately transmitting the read image to the server 60 (details of this process will be described later with reference to a flowchart). Here, only in a case where (i) the reservation in the server 60 has succeeded and (ii) communication with the mobile terminal 30 has been established so that access information can be transmitted to the mobile terminal 30, the image is transmitted to the server 60.

The access information transmitting process section 16 controls, after the image is read by the scanner section 11, the NFC I/F section 13 to transmit the access information, which has been received from the server 60, to the mobile terminal 30 with which the pairing has been established.

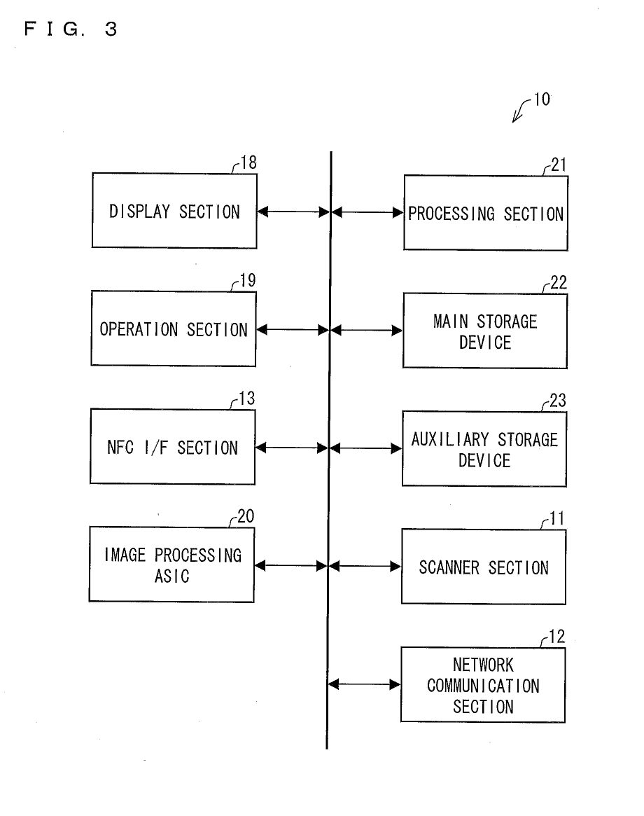

The message process section 17 prompts, after the image is read by the scanner section 11, the user to bring the mobile terminal 30 near to the specific location of the image reading device 10 at which specific location communication with the NFC I/F section 13 can be carried out. Specifically, the message process section 17 controls a display section 18 (see FIG. 3) of the image reading device 10 to display a message directed to the user.

FIG. 3 illustrates an example of a hardware configuration of the image reading device 10. The image reading device 10 includes the scanner section 11, the network communication section 12, the NFC I/F section 13, the display section 18, an operation section 19, an image processing ASIC (Application Specific Integrated Circuit) 20, a processing section 21, a main storage device 22, and an auxiliary storage device 23.

The display section 18 is a display device such as an LCD (Liquid Crystal Display) or an organic EL (Electro Luminescence) display and displays various kinds of information to the user. The operation section 19 is an input device such as a touch panel or a panel key and is used when the user operates the image reading device 10. The image processing ASIC 20 executes high load processes such as decompression of compressed data and image processing.

The processing section 21 corresponds to the CPU of the control section 14 illustrated in FIG. 1 and controls operation of each of the sections of the image reading device 10. The main storage device 22 is, for example, a DRAM (Dynamic Random Access Memory) memory into which a program (firmware), image data, and the like are loaded while a corresponding process is being executed. The auxiliary storage device 23 is a flash ROM (Read Only Memory), an HDD (Hard Disk Drive), an SD (Secure Digital) card, or the like in which a program, image data, and the like are stored.

According to present embodiment, the image reading communication apparatus is exemplified by the image reading device 10. Note, however, that the image reading communication apparatus can include a printer section for printing, on a sheet, image data which is loaded in the main storage device 22 by the processing section 21 and by the image processing ASIC 20. Alternatively, the image reading communication apparatus can be a multifunction peripheral that includes a printer section and has a facsimile transmitting function and the like.

(Configuration of Mobile Terminal 30)

The mobile terminal 30 which is included in the image transmission system 1 of the present embodiment is, for example, a smart phone, a mobile phone, or a tablet. The mobile terminal 30 includes at least a network communication section 31, an NFC interface section (hereinafter, referred to as “NFC I/F section”) 32, and a control section 33 (see FIG. 1).

The network communication section 31 is a network communication device for carrying out communication via the network 50. Specifically, the network communication section (network communication device, second network communication device) 31 communicates with the mail server 71 via the network 50 so as to transmit an email. The NFC I/F section (short-range communication device, second short-range communication device) 32 is a short-range communication device for carrying out short range wireless communication. Specifically, the NFC I/F section 32 carries out P2P communication with the image reading device 10 that is compatible with NFC.

The control section 33 includes a CPU and controls each of the sections of the mobile terminal 30. When the mobile terminal 30 approaches a specific location at which communication can be carried out with the NFC I/F section 13 of the image reading device 10 that has the NFC function, the control section 33 controls the NFC I/F section 32 to start a pairing with the image reading device 10.

Further, the present embodiment is characterized in that the control section 33 (i.e., the CPU) serves, by activating application programs (applications), as an email process section 34, an address information managing process section 35, an access information receiving process section 36, an informative mail preparing process section 37, an address information setting process section 38, and an informative mail transmitting process section 39.

Among the sections, the email process section 34 and the address information managing process section 35 carry out respective known functions. The email process section 34 prepares an email and then controls the network communication section 31 to transmit the email. The email process section 34 is realized by activating an application program for email.

The address information managing process section 35 manages address information of an information terminal to which an email is to be transmitted. The address information managing process section 35 has functions such as a function to manage an address book containing pieces of address information, an address input accepting function to accept address information inputted by a user, and an assistance function to help the user input address information. The address information managing process section 35 is realized by executing an application program for managing address information.

As is well known, the email process section 34 is linked to the address information managing process section 35, and it is therefore possible to input destination information, which indicates a destination to which an email prepared by the email process section 34 is to be transmitted, by selecting any of pieces of address information managed by the address information managing process section 35.

The access information receiving process section 36, the informative mail preparing process section 37, the address information setting process section 38, and the informative mail transmitting process section 39 are realized by activating a dedicated application program for transmitting an image. The dedicated application program is activated when the user touches a predetermined icon displayed on the mobile terminal 30 or when P2P communication with the image reading device 10 is established in NFC.

The access information receiving process section 36 controls the NFC I/F section 32 to receive access information from the image reading device 10 with which a pairing has been established. The informative mail preparing process section 37 controls the email process section 34 to prepare an informative mail which contains access information received from the image reading device 10 and indicates that the image is stored in the server 60.

The address information setting process section 38 sets, by using the address information managing process section 35, address information that indicates a destination of the informative mail which has been prepared by the informative mail preparing process section 37. The informative mail transmitting process section 39 controls the network communication section 31 to transmit the informative mail, which has been prepared by the informative mail preparing process section 37, to an information terminal indicated by the address information which has been set by the address information setting process section 38.

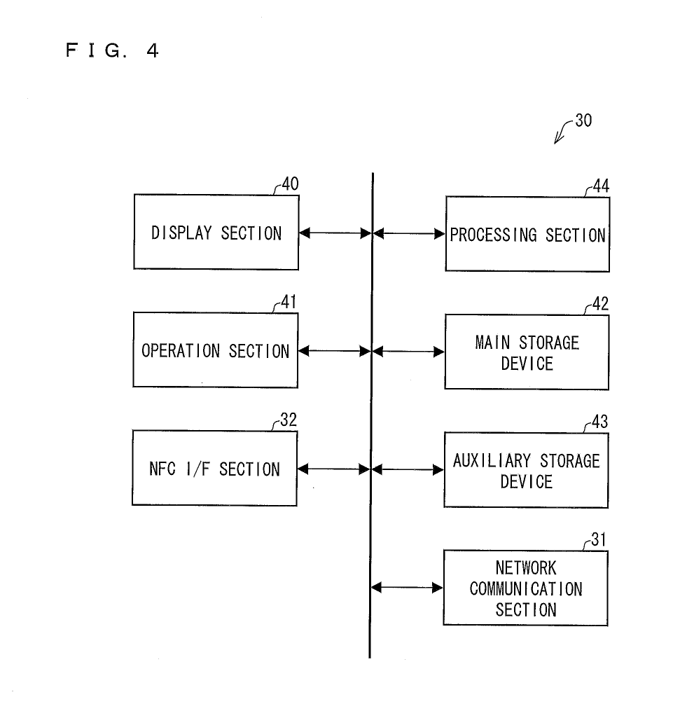

FIG. 4 illustrates an example of a hardware configuration of the mobile terminal 30. The mobile terminal 30 includes the network communication section 31, the NFC I/F section 32, a display section 40, an operation section 41, a processing section 44, a main storage device 42, and an auxiliary storage device 43.

The display section 40 is a display device such as an LCD or an organic EL display and displays various kinds of information to the user. The operation section 41 is an input device such as a touch panel or a panel key and is used when the user operates the mobile terminal 30. In a case where the mobile terminal 30 is a smart phone, the display section 40 and the operation section 41 are integrated into a display input section.

The processing section 44 is the CPU of the control section 33 illustrated in FIG. 1 and controls operation of each of the sections of the mobile terminal 30. The main storage device 42 is, for example, a DRAM memory into which a program (firmware), image data, and the like are loaded while a corresponding process is being executed. The auxiliary storage device 43 is a flash ROM, an HDD, or an SD card in which the application programs, image data, and the like are stored.

(Configuration of Server 60)

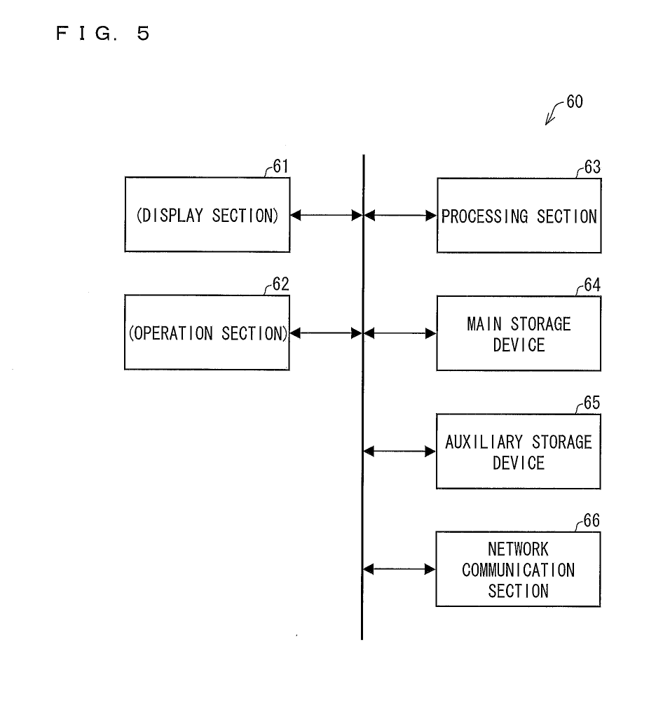

FIG. 5 illustrates an example of a hardware configuration of the server 60 which is an external server for storing an image. The server 60 is an information-processing device and includes a display section 61, an operation section 62, a processing section 63, a main storage device 64, an auxiliary storage device 65, and a network communication section 66.

The display section 61 is a display device such as an LCD or an organic EL display and displays various kinds of information to the user. The operation section 62 is an input device such as a keyboard, a mouse, or a touch panel and is used when the user operates the server 60. Note that, although the server 60 includes the display section 61 and the operation section 62 because the information-processing device is generally provided with such a display section and an operation section, the display section 61 and the operation section 62 are not essential for functions of a server.

The main storage device 64 is, for example, a DRAM memory into which a program (firmware), image data, and the like are loaded while a corresponding process is being executed. The auxiliary storage device 65 is an HDD, a magnetic tape, or the like for storing a server program, image data transmitted from the image reading device 10, and various kinds of management information.

The network communication section 66 is a network communication device for carrying out communication via the network 50. Specifically, the network communication section 66 communicates with the image reading device 10 and an arbitrary information terminal via the network 50.

The processing section 63 is a CPU that controls operation of each of the sections of the server 60. When the processing section 63 has received a request, i.e., an image storing reservation from the image reading device 10 via the network communication section 66, the processing section 63 judges, based on an amount of free space in the auxiliary storage device 65, whether or not the image for which the request has been made can be stored. In a case where the image can be stored, the processing section 63 generates access information and then transmits, via the network communication section 66, the access information to the image reading device 10 which has requested to store the image. Then, the processing section 63 (i) receives, from the image reading device 10 via the network communication section 66, the image which (a) has been requested to store and (b) is associated with the access information and (ii) causes the auxiliary storage device 65 to store the image in accordance with the access information and manages the image. Details of this process will be described later with reference to a flowchart.

When the processing section 63 has received, from an arbitrary information terminal via the network communication section 66, a request to obtain an image which has been stored in accordance with access information, the processing section 63 reads out the image from the auxiliary storage device 65 and then transmits the image to the information terminal which has made the request to obtain the image.

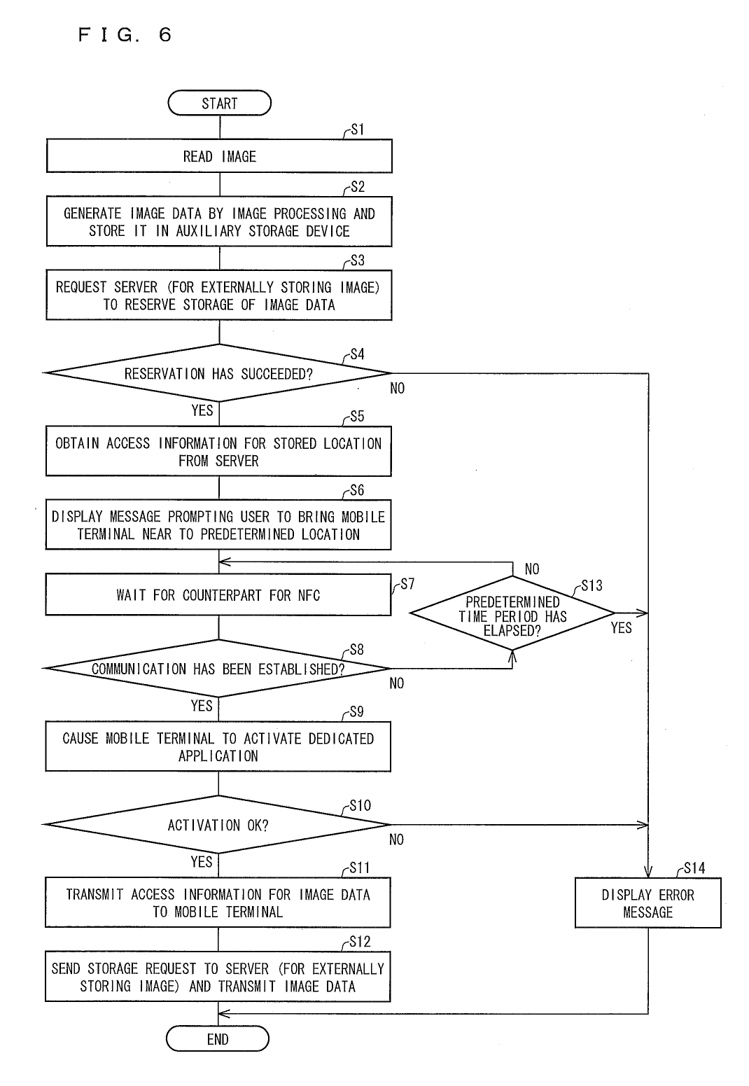

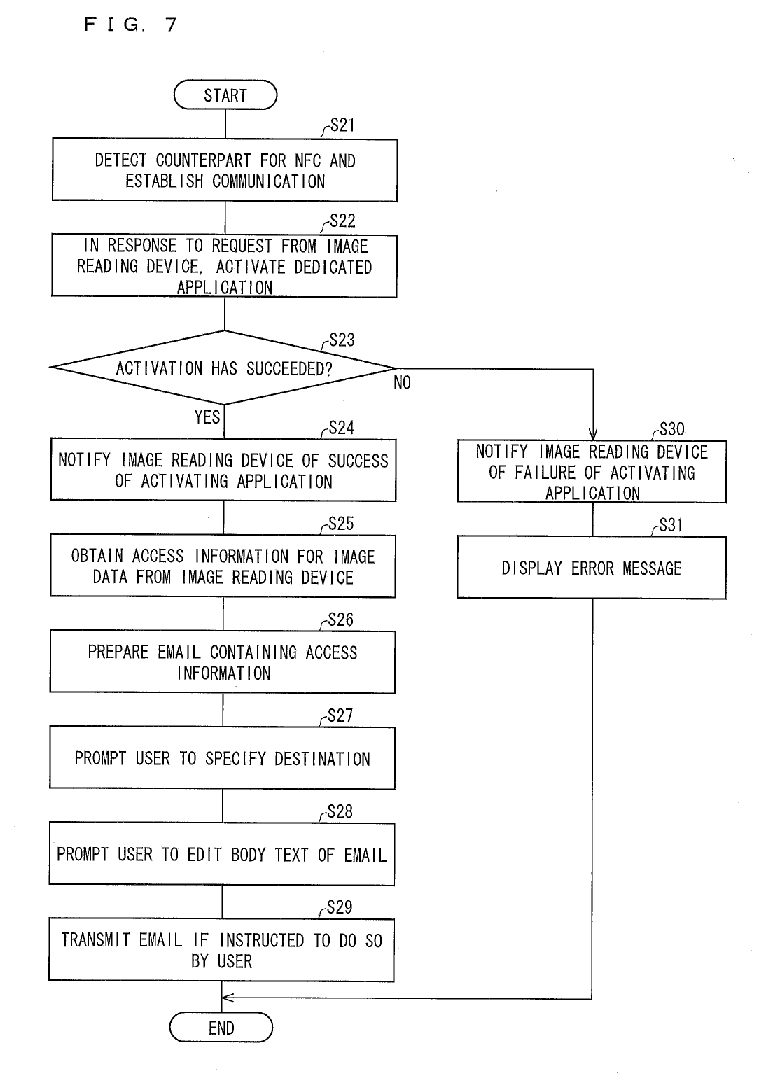

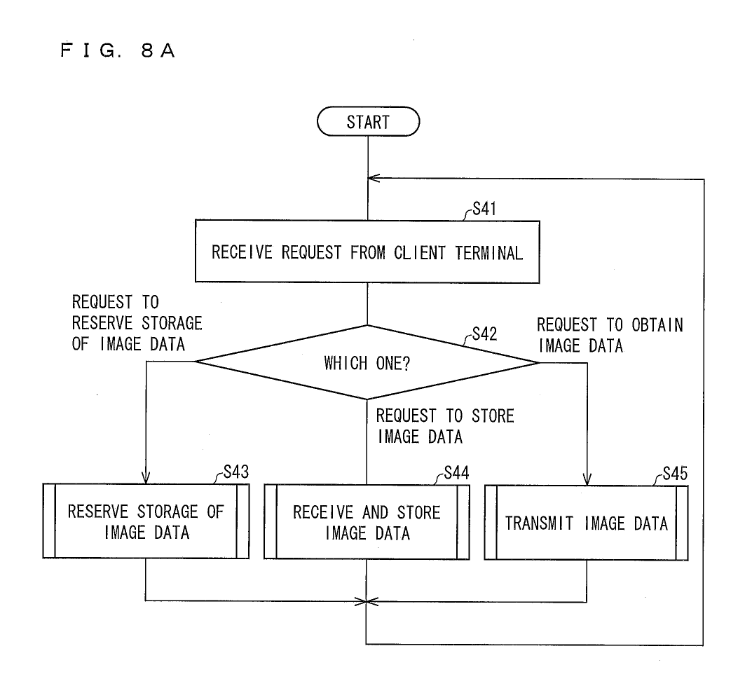

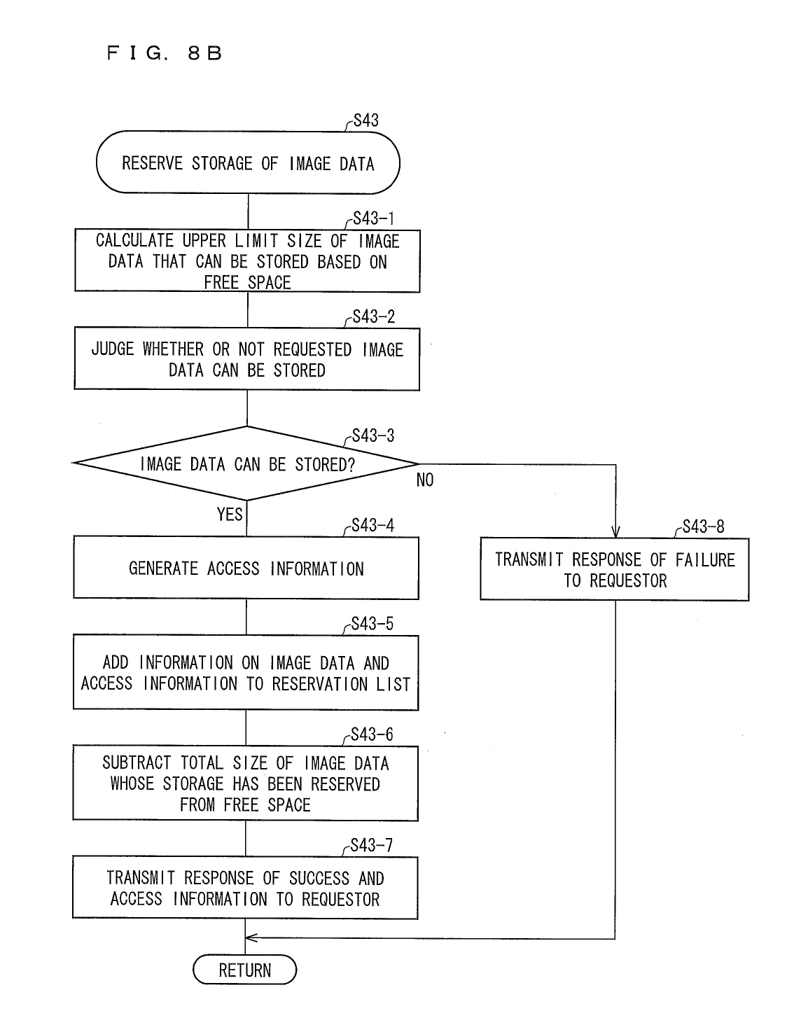

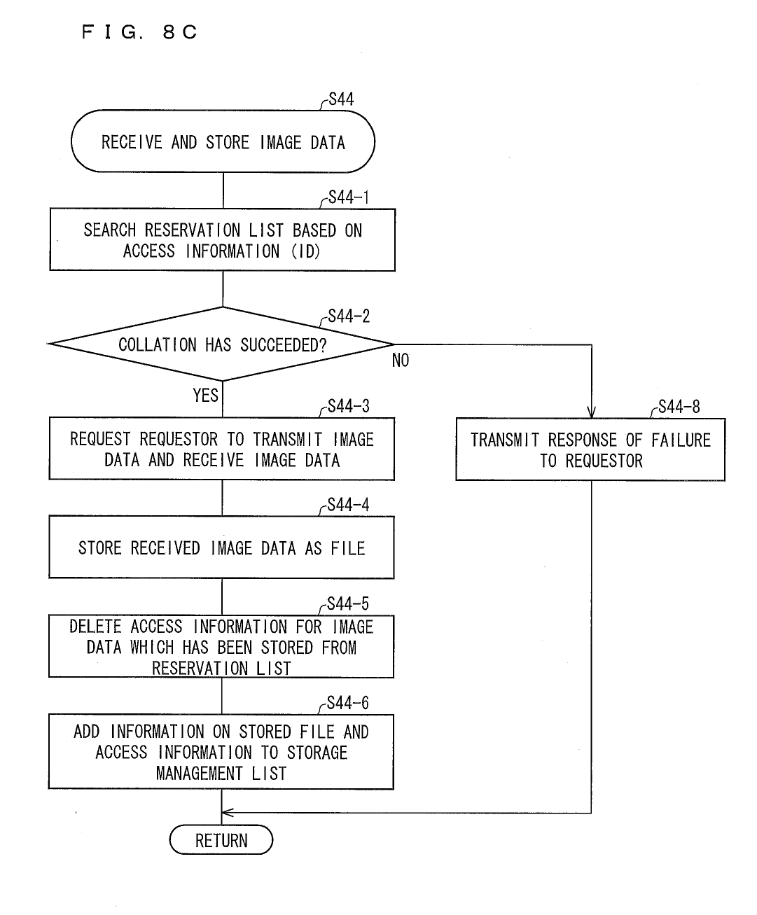

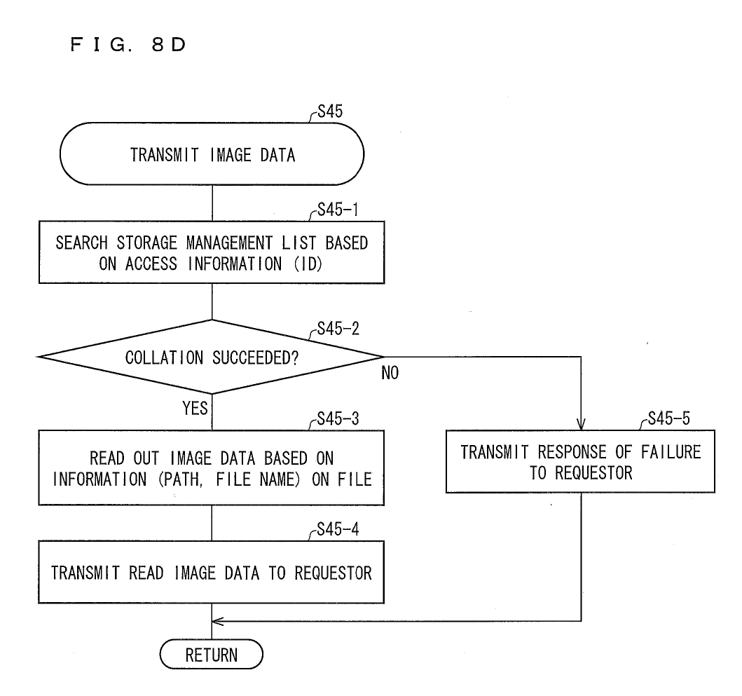

The following description will discuss operations of the image reading device 10, the mobile terminal 30, and the server 60 with reference to flowcharts illustrated in FIG. 6, FIG. 7, and FIG. 8A through FIG. 8D. FIG. 6 is a flowchart illustrating an operation of the image reading device 10. FIG. 7 is a flowchart illustrating an operation of the mobile terminal 30. FIG. 8A is a flowchart illustrating an operation of the server 60. FIG. 8B is a flowchart illustrating a subroutine in the flowchart of FIG. 8A and indicating an operation carried out in the process of reservation for storing image data. FIG. 8C is a flowchart illustrating a subroutine in the flowchart of FIG. 8A and indicating an operation carried out in the process of receiving and storing image data. FIG. 8D is a flowchart illustrating a subroutine in the flowchart of FIG. 8A and indicating an operation carried out in the process of transmitting image data.

(Operation of Image Reading Device 10)

The following description will discuss an operation of the image reading device 10. As illustrated in FIG. 6, when a user corresponding to the sender A of FIG. 1 (i) selects, with respect to the image reading device 10, an external storage mode for externally storing an image and (ii) gives an instruction on reading the image, the control section 14 (processing section 21) controls the scanner section 11 to read the image (S1). The control section 14 carries out an image processing with respect to the read image so as to generate image data and causes the auxiliary storage device 23 to store the image data (S2). Then, the control section 14 requests the server 60 to reserve a storage of the image data (S3). At this time, the control section 14 also transmits information such as a size of the image data whose storage is to be reserved.

Next, the control section 14 judges whether or not the reservation in the server 60 has succeeded (S4). Specifically, the control section 14 determines that the reservation has succeeded when access information has been transmitted from the server 60 to the control section 14. On the other hand, in a case where the control section 14 has not received access information but has been notified, by the server 60, of a result that the reservation has been failed, the control section 14 determines in S4 that the reservation has not succeeded, controls the display section 18 to display an error message (S14), and then ends the process.

In a case where the control section 14 determines that the reservation has succeeded in S4, the control section 14 receives access information which has been transmitted from the server 60 (S5). Next, the control section 14 controls the display section 18 to display a message that prompts the user to bring the mobile terminal 30 near to a predetermined location (specific location) at which the NFC can be carried out (S6) and then waits for the mobile terminal 30 to reach the predetermined location so as to carry out the NFC (S7). When the mobile terminal 30 has reached the predetermined location during the waiting state, the control section 14 starts a pairing with the mobile terminal 30 and judges whether or not communication has been established (S8). In a case where a pairing has been established, the control section 14 determines that communication has been established.

In a case where the control section 14 determines that communication has been established in S8, the control section 14 requests the mobile terminal 30 to activate a dedicated application and then the mobile terminal 30 activates the dedicated application (S9). On the other hand, in a case where the control section 14 determines that communication has not been established in S8, the control section 14 then judges whether or not a predetermined time period has elapsed (S13). In a case where the predetermined time period has not elapsed, the control section 14 returns to the process of S7. On the other hand, in a case where the predetermined time period has elapsed, the control section controls the display section 18 to display an error message (S14) and then ends the process.

In a case where the control section 14 determines that communication has been established in S8 and the control section 14 requests the mobile terminal 30 to activate the dedicated application in S9, the control section 14 then judges whether or not the dedicated application has been activated (S10). In a case where the control section 14 determines that the dedicated application has been activated, the control section 14 transmits, to the mobile terminal 30, address information which has been received from the server 60 (S11). Further, the control section 14 sends a storage request to the server 60 and then transmits image data to the server 60 (S12). Specifically, the control section 14 transmits, to the server 60, (i) access information which has been received or (ii) information (such as an ID of image data) which is contained in the access information and can be associated with image data whose storage has been reserved by the reservation request, and the control section 14 then transmits the image data (S12) after the image data is confirmed to be image data which has been reserved in the server 60. On the other hand, in a case where the control section 14 determines that the dedicated application has not been activated in S10, the control section 14 controls the display section 18 to display an error message (S14) and then ends the process.

(Operation of Mobile Terminal 30)

The following description will discuss an operation of the mobile terminal 30. As illustrated in FIG. 7, in a case where the control section 33 of the mobile terminal 30 detects the image reading device 10 with which a NFC is carried out, the control section 33 starts a pairing with the image reading device 10 so as to establish communication (S21).

Next, the control section 33 activates the dedicated application in accordance with the request from the image reading device 10 (S22). Then, the control section 33 judges whether or not the dedicated application has successfully been activated (S23). In a case where the control section 33 determines that the activation has succeeded, the control section 33 notifies the image reading device 10 of the result that the activation of the dedicated application has succeeded (S24). On the other hand, in a case where the control section 33 determines that the activation has not succeeded, the control section 33 notifies the image reading device 10 of the result that the activation of the dedicated application has been failed (S30), then controls the display section 40 to display an error message (S31), and then ends the process.

In a case where the control section 33 notifies the image reading device 10 of the result that the activation of the dedicated application has succeeded in S24, the control section 33 then obtains access information from the image reading device 10 in order to obtain image data stored in the server 60 (S25). Next, the control section 33 prepares an email (informative mail) that contains the access information (S26). Then, the control section 33 causes a screen for inputting a destination of the email to be displayed so as to prompt the user to input destination information of a receiver to whom the email is to be transmitted (S27). Subsequently, the control section 33 causes a screen, on which the user can edit a body text of the email, to be displayed and accepts the editing (S28). After that, when the control section 33 has accepted, from the user, an instruction on transmitting the email, the control section 33 transmits the email (informative mail) containing the access information to a destination which is indicated by the destination information inputted in S27 (S29). Note that the step S28, in which the screen is displayed for the user to edit a body text of the email, can be, as appropriate, (i) replaced with a step in which the screen is displayed in accordance with an instruction given from the user or (ii) omitted.

(Operation of Server 60)

The following description will discuss an operation of the server 60. As illustrated in FIG. 8A, when the processing section 63 of the server 60 has received a request from a client terminal (S41), the processing section 63 judges whether the request is (i) a request for a reservation for storing image data, (ii) a request for storing image data, or (iii) a request for obtaining image data (S42).

In a case where the request is a request for a reservation for storing image data, the process proceeds to S43. In a case where the request is a request for storing image data, the process proceeds to S44. In a case where the request is a request for obtaining image data, the process proceeds to S45.

In S43, the processing section 63 carries out a process of a reservation for storing image data (see FIG. 8B). As illustrated in FIG. 8B, the processing section 63 calculates, with reference to a free space in the auxiliary storage device 65, an upper limit size of image data to be stored (S43-1). Then, the processing section 63 judges, based on the calculation result, whether or not to store the image data for which the storage reservation has been requested by the image reading device 10 (S43-2). In S43-3, whether or not the image data can be stored is judged based on the judgment result of S43-2, and in a case where the processing section 63 determines that the image data can be stored, the processing section 63 generates access information (S43-4). On the other hand, in a case where the processing section 63 determines that the image data cannot be stored, the processing section 63 notifies the image reading device 10, which has made the request for reservation, of the result that the image data cannot be stored (S43-8).

In a case where access information is generated in S43-4, the processing section 63 adds (i) information regarding the image data to be stored and (ii) the generated access information to a reservation list which is provided in the auxiliary storage device 65 (S43-5). Further, the processing section 63 subtracts a total size of the image data, whose storage has been reserved, from the free space (S43-6).

Subsequently, the processing section 63 transmits (i) a response indicating that the image data can be stored and (ii) the access information to the image reading device 10 which has made the request (S43-7).

In S44, the processing section 63 carries out a process of receiving and storing image data (see FIG. 8C). As illustrated in FIG. 8C, the processing section 63 searches the reservation list based on (i) the access information received from the image reading device 10 or (ii) the information which is contained in the access information and can be associated with the image data whose storage has been reserved by the reservation request (S44-1).

Next, the processing section 63 judges whether or not a collation has succeeded (S44-2). Specifically, in a case where the access information exists in the reservation list, the processing section 63 determines that the collation has succeeded, whereas, in a case where the access information does not exist in the reservation list, the processing section 63 determines that the collation has been failed. In a case where the processing section 63 determines that the collation has succeeded, the processing section 63 requests the image reading device 10, which has requested to store the image data, to transmit the image data, and then receives the transmitted image data (S44-3). On the other hand, in a case where the processing section 63 determines that the collation has been failed, the processing section 63 transmits, to the image reading device 10 which has made the request, a response which indicates that the image data cannot be stored (S44-8).

In a case where the processing section 63 has received the image data from the image reading device 10 in S44-3, the processing section 63 causes the auxiliary storage device 65 to store the received image data (S44-4) as a file.

Subsequently, the processing section 63 deletes, from the reservation list, (i) the information regarding the image data which has been stored and (ii) the access information corresponding to the image data (S44-5), and the processing section 63 adds (i) information regarding the stored image file (i.e., the file in which the image data is contained) and (ii) the generated access information to a storage management list which is provided in the auxiliary storage device 65 (S44-6).

In S45, the processing section 63 carries out a process of transmitting image data (see FIG. 8D). As illustrated in FIG. 8D, the processing section 63 searches the storage management list based on the access information which has been received from the information terminal 72 of the receiver B to which the image is to be transmitted (S45-1). Then, the processing section 63 judges whether or not a collation has succeeded (S45-2). Specifically, in a case where the access information exists in the storage management list, the processing section 63 determines that the collation has succeeded, whereas, in a case where the access information does not exist in the storage management list, the processing section 63 determines that the collation has been failed. In a case where the processing section 63 determines that the collation has succeeded, the processing section 63 reads out the image data based on information (i.e., a path, a name of the file) regarding the stored file (S45-3), and then the processing section 63 transmits the image data to the information terminal 72 of the receiver B who has requested the image data (S45-4). On the other hand, in a case where the processing section 63 determines that the collation has been failed in S43-2, the processing section 63 transmits, to the information terminal 72 of the receiver B who has requested the image data, a response which indicates that the image data is not stored (S45-5).

In the present embodiment, the free space in the server 60 is managed in the server program as a “logical” free space which is a specific region (capacity) dedicated to the server program in the auxiliary storage device. Alternatively, the following method can be employed: that is, a free space of the server 60 is managed in a file system (OS level), a total size of image data, whose storage is reserved, is managed by a server program (application level), and a maximum size of image data that can be stored is calculated with reference to both the free space of the server 60 and the total size image data.

As above described, according to the image transmission system 1 of the present embodiment, a receiver can obtain an image, which has been read by the image reading device 10, by simple procedures such as selecting from pieces of destination information which are managed in the address information managing process section 35 that is an existing function of the mobile terminal 30, without (i) inputting destination information into the image reading device 10 and (ii) informing the receiver of access information for the image data, which is externally stored, by email or by telephone. Moreover, various countermeasures for easy input are devised in the present invention and the user can set destination information with the use of his/her own mobile terminal 30 which the user is accustomed to operating. Therefore, even in a case where destination information is not managed in the address information managing process section 35 of the mobile terminal 30, it is possible to set destination information significantly easily, as compared with a case where destination information is set with the use of the image reading device 10.

As another embodiment, it is possible to employ a method in which a user authentication is carried out by utilizing a NFC. In such a case, the user is registered in advance to use the image transmission system 1, and the server 60 manages information on users who are permitted to use the image transmission system 1. When a process of reading and transmitting an image is carried out, the user transmits authentication information to the image reading device 10 by the use of his/her own mobile terminal 30 via a NFC, and the authentication information is transferred from the image reading device 10 to the server 60. Then, an authentication is carried out in the server 60, and the server 60 permits to store image data only when the user has been registered to use the image transmission system 1.

In the above description, the control section 14 of the image reading device 10 and the control section 33 of the mobile terminal 30 are realized by software with the use of the CPU (Central Processing Unit). Note, however, that each of the control section 14 and the control section 33 can alternatively be realized by a logic circuit (hardware) provided in an integrated circuit (IC chip) or the like.

In the former case, each of the control section 14 of the image reading device 10 and the control section 33 of the mobile terminal 30 includes: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium (such as a communication network and a broadcast wave) which enables transmission of the program. Note that the present invention can also be implemented by the program in the form of a computer data signal embedded in a carrier wave which is embodied by electronic transmission.

[Main Points]

The image transmission system in accordance with an aspect 1 of the present invention includes: an image reading communication apparatus (image reading device) that includes a scanner section 11 for reading an image, a first network communication device (network communication section 12) for carrying out communication via a network, and a first short-range communication device (NFC I/F section 13) for carrying out short range wireless communication; and a mobile terminal that includes a second network communication device (network communication section 31) for carrying out communication via the network, a second short-range communication device (NFC I/F section 32) for carrying out the short range wireless communication, email means (email process section 34) for preparing an email and controlling the second network communication device to transmit the email, and address information managing means (address information managing process section 35) for managing address information of an information terminal to which the email is transmitted, the image reading communication apparatus further including: storing means (storing process section 15) for externally storing an image, the storing means (i) controlling the scanner section to read an image, (ii) controlling the first network communication device to transmit the image, which has been read, to a server so that the image is stored in the server, and (iii) receiving, from the server, access information which is used to access the server so as to obtain the image stored in the server, and access information transmitting means (access information transmitting process section 16) for controlling, after the image is read by the scanner section, the first short-range communication device to transmit the access information to the mobile terminal with which a pairing has been established, the mobile terminal further including: access information receiving means (access information receiving process section 36) for controlling the second short-range communication device to receive the access information from the image reading communication apparatus with which the pairing has been established, informative mail preparing means (informative mail preparing process section 37) for controlling the email means to prepare an informative mail which (i) contains the access information which has been received from the image reading communication apparatus and (ii) indicates that the image is stored in the server, address information setting means (address information setting process section 38) for setting, with use of the address information managing means, address information that indicates a destination of the informative mail, and informative mail transmitting means (informative mail transmitting process section 39) for controlling the second network communication device to transmit the informative mail to an information terminal which is indicated by the address information.

According to the configuration, the storing means of the image reading communication apparatus (i) causes the external server to store the read image and (ii) receives, from the server, access information which is used to access the server so as to obtain the image from the server. The access information, which has been received, is supplied to the mobile terminal when short range wireless communication is carried out between the access information transmitting process section of the image reading communication apparatus and the access information receiving process section of the mobile terminal with the use of the short-range communication devices.

In the mobile terminal, the informative mail preparing means (informative mail transmitting process section 39) controls the email means to prepare an informative mail that contains the access information received from the image reading communication apparatus and indicates that the image is stored in the server. Further, the address information setting means sets address information which indicates a destination of the informative mail with the use of the address information managing means, and the informative mail transmitting means controls the second network communication device to transmit the informative mail to an information terminal which is indicated by the set address information.

With the configuration, a receiver can obtain an image by simple procedures such as selecting from destination information which is managed in the address information managing process section that is an existing function of the mobile terminal, without (i) inputting destination information into the image reading communication apparatus and (ii) informing the receiver of access information for the image data, which is externally stored, by email or by telephone. Moreover, various countermeasures for easy input are devised in general mobile terminals and the user can set destination information with the use of his/her own mobile terminal which the user is accustomed to operating. Therefore, even in a case where destination information is not managed in the address information managing means (address information managing process section 35) of the mobile terminal, it is possible to set destination information significantly easily, as compared with a case where destination information is set with the use of the image reading communication apparatus (image reading device 10).

The image reading communication apparatus (image reading device 10) can further includes a message means for prompting, after an image is read, a user to bring the mobile terminal near to a specific location at which communication is enabled with the first short-range communication device (NFC I/F section 13) of the image reading communication apparatus.

This allows even a user, who is not accustomed to the image transmission system of the present invention, to easily use the image transmission system.

The mobile terminal can serve, by executing an application program, as the access information receiving means (access information receiving process section 36), the informative mail preparing means (informative mail preparing process section 37), the address information setting means (address information setting process section 38), and the informative mail transmitting means (informative mail transmitting process section 39); and the application program can be activated in response to a request from the image reading communication apparatus with which the pairing has been established.

According to the configuration, the functions of the mobile terminal in the image transmission system are achieved by executing the application program, and the application program is activated in response to the request from the image reading communication apparatus. This further improves operationality.

The image reading communication apparatus (image reading device 10) in accordance with an aspect 2 of the present invention includes: a scanner section 11 for reading an image; a network communication device (network communication section 12) for carrying out communication via a network; a short-range communication device (NFC I/F section 13) for carrying out short range wireless communication; storing means (storing process section 15) for externally storing an image, the storing means (i) controlling the scanner section to read an image, (ii) controlling the network communication device to transmit the image, which has been read, to a server so that the image is stored in the server, and (iii) receiving, from the server, access information which is used to access the server so as to obtain the image stored in the server, and

access information transmitting means (access information transmitting process section 16) for controlling, after the image is read by the scanner section, the short-range communication device to transmit the access information to a mobile terminal with which a pairing has been established.

The mobile terminal 30 in accordance with an aspect 3 of the present invention includes: a network communication device (network communication section 31) for carrying out communication via a network; a short-range communication device (NFC I/F section 32) for carrying out short range wireless communication; email means (email process section 34) for preparing an email and controlling the network communication device to transmit the email; address information managing means (address information managing process section 35) for managing address information of an information terminal to which the email is transmitted; access information receiving means (access information receiving process section 36) for controlling the short-range communication device to receive access information from an image reading communication apparatus (image reading device 10) with which a pairing has been established, the access information being used to access the server 60 in order to obtain an image stored in the server; informative mail preparing means (informative mail preparing process section 37) for controlling the email means to prepare an informative mail which (i) contains the access information and (ii) indicates that the image is stored in the server; address information setting means (address information setting process section 38) for setting, with use of the address information managing means, address information that indicates a destination of the informative mail; and informative mail transmitting means (informative mail transmitting process section 39) for controlling the network communication device to transmit the informative mail to an information terminal which is indicated by the address information.

The method for transmitting an image in accordance with an aspect 4 of the present invention is a method for transmitting an image via a server which is provided on a network, and the method includes the steps of: reading an image by an image reading communication apparatus; causing the server to store the image which has been read by the image reading communication apparatus; receiving, by the image reading communication apparatus, access information from the server, the access information being used to access the server so as to obtain the image stored in the server; transmitting, after the image is read, the access information from the image reading communication apparatus to a mobile terminal with which a pairing has been established in short range wireless communication; preparing an email, which indicates that the image is stored in the server, by use of the mobile terminal which has received the access information from the image reading communication apparatus with which the pairing has been established in the short range wireless communication; transmitting the email, which contains the access information which has been received, from the mobile terminal to an arbitrary information terminal which is indicated by arbitrarily set address information; and obtaining the image, which is stored, by causing the arbitrary information terminal to access the server with reference to the access information.

The image reading communication apparatus and the mobile terminal in accordance with each aspect of the present invention can be realized by a computer. In such a case, the present invention encompasses (i) a program which causes the computer to serve as the above described means for realizing the image reading communication apparatus and the mobile terminal and (ii) a computer-readable storage medium storing the program.

The present invention is not limited to the embodiments, but can be altered by a skilled person in the art within the scope of the claims. An embodiment derived from a proper combination of technical means disclosed in respective different embodiments is also encompassed in the technical scope of the present invention. Further, it is possible to form a new technical feature by combining the technical means disclosed in the respective embodiments.

### REFERENCE SIGNS LIST

1: Image transmission system
10: Image reading device (image reading communication apparatus)
11: Scanner section
12: Network communication section (network communication device, first network communication device)
13: NFC interface section (short-range communication device, first short-range communication device)
14: Control section
15: Storing process section for externally storing an image (storing means for externally storing an image)
16: Access information transmitting process section (access information transmitting means)
17: Message process section (message means)
18: Display section
19: Operation section
21: Process section
22: Main storage device
23: Auxiliary storage device
30: Mobile terminal
31: Network communication section (network communication device, second network communication device)
32: NFC interface section (short-range communication device, second short-range communication device)
33: Control section
34: Email process section (email means)
35: Address information managing process section (address information managing means)
36: Access information receiving process section (access information receiving means)
37: Informative mail preparing process section (informative mail preparing means)
38: Address information setting process section (address information setting means)
39: Informative mail transmitting process section (informative mail transmitting means)
40: Display section
41: Operation section
42: Main storage device
43: Auxiliary storage device
44: Access information receiving process section
50: Network
60: Server
61: Display section
62: Operation section
63: Process section
64: Main storage device
65: Auxiliary storage device
66: Network communication section
71: Mail server
72: Information terminal

1. An image transmission system comprising:
an image reading communication apparatus that includes a scanner section for reading an image, a first network communication device for carrying out communication via a network, and a first short-range communication device for carrying out short range wireless communication; and
a mobile terminal that includes a second network communication device for carrying out communication via the network, a second short-range communication device for carrying out the short range wireless communication, email means for preparing an email and controlling the second network communication device to transmit the email, and address information managing means for managing address information of an information terminal to which the email is transmitted,
the image reading communication apparatus further including:
storing means for externally storing an image, the storing means (i) controlling the scanner section to read an image, (ii) controlling the first network communication device to transmit the image, which has been read, to a server so that the image is stored in the server, and (iii) receiving, from the server, access information which is used to access the server so as to obtain the image stored in the server, and
access information transmitting means for controlling, after the image is read by the scanner section, the first short-range communication device to transmit the access information to the mobile terminal with which a pairing has been established,
the mobile terminal further including:
access information receiving means for controlling the second short-range communication device to receive the access information from the image reading communication apparatus with which the pairing has been established,
informative mail preparing means for preparing, with use of the email means, an informative mail which (i) contains the access information which has been received from the image reading communication apparatus and (ii) indicates that the image is stored in the server,
address information setting means for setting, with use of the address information managing means, address information that indicates a destination of the informative mail, and
informative mail transmitting means for controlling the second network communication device to transmit the informative mail to an information terminal which is indicated by the address information.

2. The image transmission system as set forth in claim 1, wherein:
the image reading communication apparatus further includes a message means for prompting, after an image is read, a user to bring the mobile terminal near to a specific location at which communication is enabled with the first short-range communication device of the image reading communication apparatus.

3. The image transmission system as set forth in claim 1, wherein:
the mobile terminal serves, by executing an application program, as the access information receiving means, the informative mail preparing means, the address information setting means, and the informative mail transmitting means; and
the application program is activated in response to a request from the image reading communication apparatus with which the pairing has been established.

4. An image reading communication apparatus, comprising:
a scanner section for reading an image;
a network communication device for carrying out communication via a network;
a short-range communication device for carrying out short range wireless communication;
storing means for externally storing an image, the storing means (i) controlling the scanner section to read an image, (ii) controlling the network communication device to transmit the image, which has been read, to a server so that the image is stored in the server, and (iii) receiving, from the server, access information which is used to access the server so as to obtain the image stored in the server, and
access information transmitting means for controlling, after the image is read by the scanner section, the short-range communication device to transmit the access information to a mobile terminal with which a pairing has been established.

5. A non-transitory computer-readable storage medium that stores a program for causing a computer to serve as each of the means of the image reading communication apparatus recited in claim 4.

6. A mobile terminal comprising:
a network communication device for carrying out communication via a network;
a short-range communication device for carrying out short range wireless communication;
email means for preparing an email and controlling the network communication device to transmit the email;
address information managing means for managing address information of an information terminal to which the email is transmitted;
access information receiving means for controlling the short-range communication device to receive access information from an image reading communication apparatus with which a pairing has been established, the access information being used to access a server in order to obtain an image stored in the server;
informative mail preparing means for preparing, with use of the email means, an informative mail which (i) contains the access information and (ii) indicates that the image is stored in the server;
address information setting means for setting, with use of the address information managing means, address information that indicates a destination of the informative mail; and
informative mail transmitting means for controlling the network communication device to transmit the informative mail to an information terminal which is indicated by the address information.

7. A non-transitory computer-readable storage medium that stores a program for causing a computer to serve as each of the means of the mobile terminal recited in claim 6.

8. A method for transmitting an image via a server which is provided on a network, said method comprising the steps of:
reading an image by an image reading communication apparatus;
causing the server to store the image which has been read by the image reading communication apparatus;
receiving, by the image reading communication apparatus, access information from the server, the access information being used to access the server so as to obtain the image stored in the server;
transmitting, after the image is read, the access information from the image reading communication apparatus to a mobile terminal with which a pairing has been established in short range wireless communication;
preparing an email, which indicates that the image is stored in the server, by use of the mobile terminal which has received the access information from the image reading communication apparatus with which the pairing has been established in the short range wireless communication;
transmitting the email, which contains the access information which has been received, from the mobile terminal to an arbitrary information terminal which is indicated by arbitrarily set address information; and
obtaining the image, which is stored, by causing the arbitrary information terminal to access the server with reference to the access information.
